(19) United States
(12) Patent Application Publication
(10) Pub. No.: US 2009/0327511 A1
(43) Pub. Date: Dec. 31, 2009

(54) Message conversion apparatus for integrated monitoring of industrial equipment

(76) Inventors: Woo Sung Kim, Cheonan-si (KR); Yong Muk Lim, Cheonnan-si (KR); Sun Goo Kang, Cheonan-si (KR)

Correspondence Address: Royal W. Craig, Esq.;Ober/Kaler, 120 East Baltimore Street, Baltimore, MD, 21202-1643, US

(21) Appl. No.: 12/317,589

(22) Filed: Dec. 24, 2008

(30) Foreign Application Priority Data
Jun. 27, 2008 (KR) 10-2008-0061334

(51) Int. Cl. G06F 15/173

(52) U.S. Cl. 709/232

(57) ABSTRACT

Disclosed is a message conversion apparatus for integrated monitoring of industrial equipment capable of integrated management and monitoring using the internet or computer networks, by extracting data conforming to a predetermined Self Description from each message of different communication protocols and converting it into XML message format, when transmitting status and operational message from semiconductor equipment or industrial automation PLC equipment to a server.

### CROSS-REFERENCE TO RELATED APPLICATION

The present application is based on, and claims priority from, Korean Application Number 10-2008-0061334 filed Jun. 27, 2008, the disclosure of which is incorporated herein by reference in its entirety.

### BACKGROUND

1. Field of the Invention

The present invention relates generally to conversion of a message transmitted between industrial equipment and a server, and particularly to a message conversion apparatus for integrated monitoring of industrial equipment capable of converting a message transmitted between the industrial equipment and a server into an integrated message format to enable integrated management and monitoring using the internet or a computer network when transmitting operational and status messages from semiconductor equipment or industrial automated programmable logic controller (PLC) equipment to a server.

2. Description of the Background

Collecting all status data related to production in a semiconductor manufacturing process is very important. This is because the collected data can be analyzed and then utilized to asses and/or control the operating rate of equipment, failure diagnosis, process control, and removal of obstacles or errors, all of which can positively contribute to improving production efficiency.

The semiconductor industry is a device-intensive industry so that many kinds of equipment are needed in manufacturing process, and various communication protocols and messages are used. Most of the initial automated semiconductor equipment has characteristics of a low speed such as 1000 bps and a hardware-dependency by RS-232C communication method like Programmable Logic Controller (PLC) and Semiconductor Equipment Communication Standard-I (SECS-I), which results in dissatisfaction.

In order to address such dissatisfaction, a new protocol called High-Speed SECS Message Services (HSMS) was introduced in 1995, which exchanges messages using the established TCP/IP communication method. The HSMS is free from the hardware-dependency and supports the communication with a high speed of 10 Mbps by using the TCP/IP communication method.

However, the HSMS cannot support the existing SECS-I and PLC communication protocol. Further, since the SECS-I and the HSMS are using the Semiconductor Equipment and Materials International (SEMI) Communication Standard-II (SECS-II) messages and the PLC is using OLE for Process Control (OPC) standard messages, it is difficult to perform integrated management and monitoring.

Although an easier way to integrate the automation equipment is to replace the initial equipment for the purpose of addressing such problem, replacing all existing equipment can be a waste of time, and is very costly. Because the internet and computer networks have expanded the range of equipment monitoring, there is a need for a method which can utilize the existing equipment with the new equipment by using HTTP/SOAP protocol and use new equipment and technology such as monitoring in a mobile environment using a PDA.

### SUMMARY OF THE INVENTION

An object of the present invention is to provide a message conversion apparatus for integrated monitoring of industrial equipment capable of performing integrated management and monitoring of the industrial equipment using the internet or computer networks, by converting messages using different communication regulations into an integrated message format (eXtensible Markup Language (XML)) when transmitting status and operational messages from the semiconductor equipment or industrial automation equipment to a server.

In one general aspect, a message conversion apparatus for unified monitoring of industrial equipment comprises an SECS analyzer for analyzing the Header and Data of Semiconductor Equipment Communications Standard-II message transmitted from the semiconductor equipment and for extracting data included in the message; an OPC converter for generating data of object linking and embedding (OLE) for Process Control (OPC) protocol by analyzing PLC message transmitted from a PLC equipment; a data processor for processing mapping operation of data inputted from the SECS analyzer or the OPC converter to a predetermined element of Self Description to extract data conforming to an element of Self Description; and an XML converter for converting the message data mapped to the element of Self Description inputted from the data processor into an eXtensible Markup Language (XML) message format.

Specifically, the SECS analyzer receives the SECS-II message from the semiconductor equipment through SECS-I protocol or High-Speed SECS Message Services (HSMS) protocol.

Further, the element of Self Description is classified into a Header part and a Message Value part, where the Header part includes an element Protocol indicating a communication protocol through which the SECS-II or the OPC message is transmitted, an element Control Message indicating control text of the SECS-II or the OPC message, an element Device ID indicating an identification code of the industrial equipment transmitting the SECS-II or OPC message, an element Stream indicating Stream information of the SECS-II or OPC message, an element Function indicating a Function information of the SECS-II or OPC message, and an element Data Length indicating a message length of the SECS-II or OPC message.

Further, the element Protocol of the Header part is a SECS-I, HSMS or OPC protocol.

Further, the Header part further includes an element Direction indicating a classification code which causes each message to be classified in accordance with a predetermined classification criterion for each property of the SECS-II or OPC message, and the corresponding classification code is mapped to the element Direction by analyzing the extracted message data to confirm the property of the SECS-II or OPC message and classifying the message in accordance with the predetermined classification criterion, when mapping the extracted message data to the predetermined element of Self Description. The element Direction also indicates identification information of a monitoring integrated server pre-assigned to monitor the message in accordance with the property of the SECS-II or OPC message.

Further, the Message Value part comprises an element List indicating a List information of the SECS-II or OPC message and an Item information of the SECS-II or OPC message.

Further, the XML converter transmits the converted XML data to the integrated server through Simple Object Access Protocol (SOAP).

### BRIEF DESCRIPTION OF THE DRAWINGS

FIG. 1 is a schematic diagram illustrating a system for converting messages transmitted between industrial equipment and a server according to the present invention.

FIG. 2 is a diagram illustrating a structure of SECS-II messages transmitted through SECS-I protocol.

FIG. 3 is a diagram illustrating each of elements of Self Description used for data conversion according to the present invention.

FIGS. 4 and 5 are drawings illustrating respective structures of SECS-II message and OPC message.

FIG. 6 is a diagram illustrating a schema of a XML Header part converted according to the present invention.

FIG. 7 is a drawing illustrating a schema of a XML Data part converted according to the present invention.

FIG. 8 is a flow chart illustrating procedures of converting messages transmitted between industrial equipment and a server according to the present invention.

### DETAILED DESCRIPTION

Hereinafter, exemplary implementations of the present inventive disclosure will be described in detail with reference to the accompanying drawings.

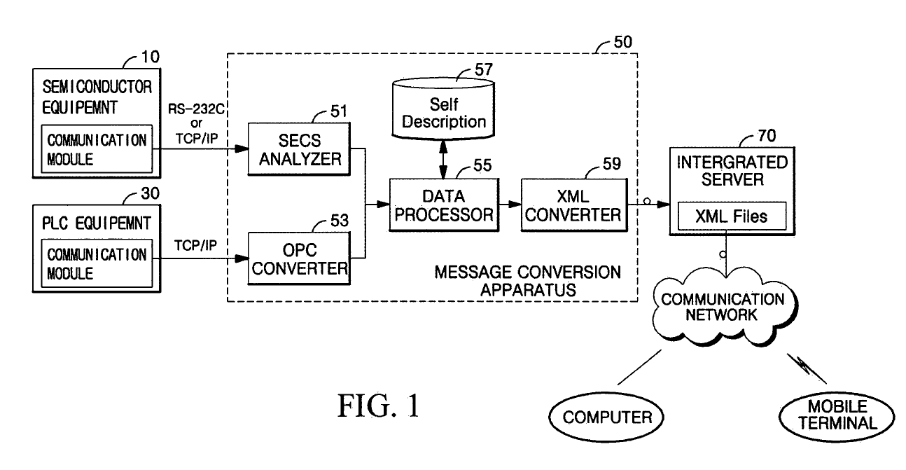

FIG. 1 is a drawing illustrating a system for converting messages transmitted between industrial equipment 10, 30 and a server 70 according to the present invention. The industrial equipment here includes semiconductor equipment 10, and programmable logic control (PLC) equipment 30. The semiconductor equipment 10 is configured in such a way that, after collecting all status data related to the semiconductor production, the collected data are converted into SECS-II messages according to SECS-I protocol (SECS-I defining how the data is transmitted, while SECS-II defines what data is transmitted), and the converted data is transmitted to a message conversion apparatus 50 using RS-232C serial communication, or alternatively, the collected data are converted into SECS-II message of High-Speed SECS Message Services (HSMS) protocol and is then transmitted to the message conversion apparatus 50 using TCP/IP. The HSMS protocol receives less restriction upon a communication speed and a cable length compared with the SECS-I protocol, because it uses TCP/IP. PLC equipment 30 is configured to collect all data related to operation and control, convert the collected data into a PLC message, and transmit the PLC message to the message conversion apparatus 50 using TCP/IP.

The message conversion apparatus 50 is configured in such a way that it is communicates with the semiconductor equipment 10 transmitting the SECS-II message, or it is connected to the PLC equipment 30 transmitting the PLC message, and analyzes a Header part of the SECS-II and PLC messages transmitted from the equipment 10, 30. For both the SECS-II and PLC messages, message conversion apparatus 50 extracts data conforming to a predetermined Self Description 57 and converts it into XML message format.

The integrated management and monitoring of the messages of the industrial equipment 10, 30 can be realized by standardizing the message format of the semiconductor equipment 10 and the PCL equipment 30, which use different protocols, via the message conversion apparatus 50.

The message conversion apparatus 50 further includes an SECS analyzer 51, an OPC converter 53, a data processor 55, and a XML converter 59. The SECS analyzer 51 is configured to extract data contained in the message by analyzing a Header part and a Data part of SECS-II message received through the SECS-I protocol or the HSMS protocol. A variety of commercially available protocol analyzer products are available for this purpose, e.g., Network Associates, NetXray, Shomiti, etc. The OPC converter 53 is configured to generate data of OLE for Process Control (OPC) protocol by analyzing the PLC message transmitted from the PLC equipment 30. Likewise, there are various ‘off the shelf’ solutions for PLC to OPC conversion. The data processor 55 may be a conventional processor or logic array configured as described below to perform an operation of mapping the data inputted from the SECS analyzer 51 or the OPC converter 53 to predetermined elements of Self Description and extract data conforming to the elements of the Self Description 57. The XML converter 59 is configured to convert the message data mapped to the elements of the Self Description inputted from the data processor 55 into an XML message and transmit it to the integrated server 70 through a Simple Object Access Protocol (SOAP). Herein, the Self Description 57 defines various classes necessary for each function of message that is separated.

The XML document completed by the message conversion apparatus 50 is transmitted to the integrated server 70 where it is managed, and clients and engineers can access the integrated server 70 through a wired/wireless line using a computer and a mobile terminal to monitor operation and status of the industrial equipment.

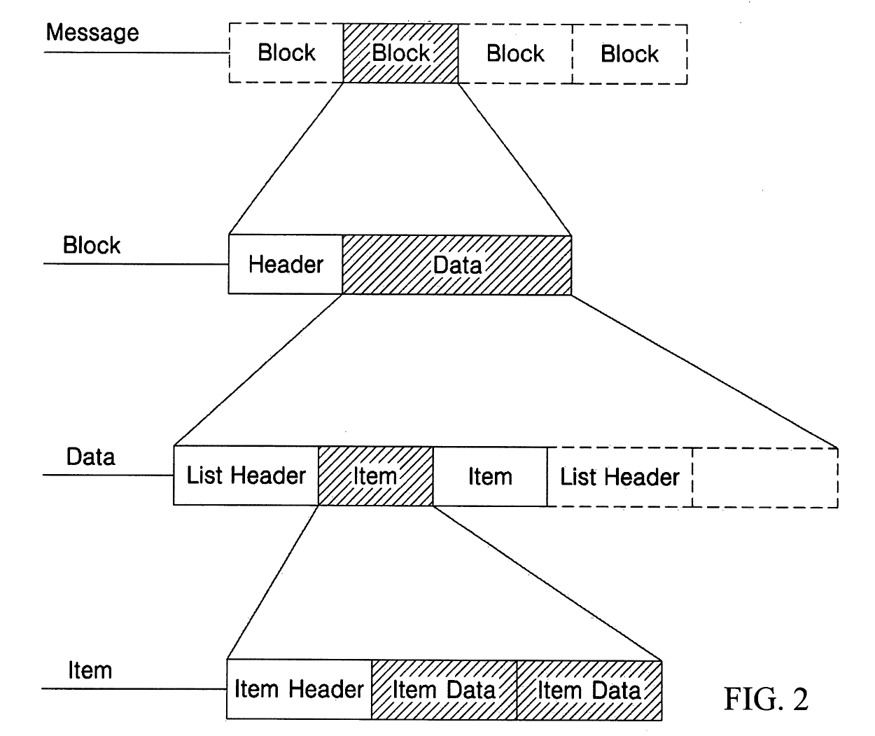

A structure of SECS-II message transmitted from the semiconductor equipment 10 is configured such as in FIG. 2, in which the SECS-II message includes block units where each block unit consisted of a Header part and a Data part. As shown in FIG. 2, the Data part of the SECS-II message includes a List and an Item, in which the List stores the number of lower nodes on the data structure and the Item stores actual data, whereby the SECS analyzer 51 analyzes the Header and the Data of the message transmitted through the SECS-I protocol or the HSMS protocol to extract the data included in the message. The data processor 55 maps the message data to the element of Self Description 57, which is a standard designed to include the message data extracted from the SECS analyzer 51.

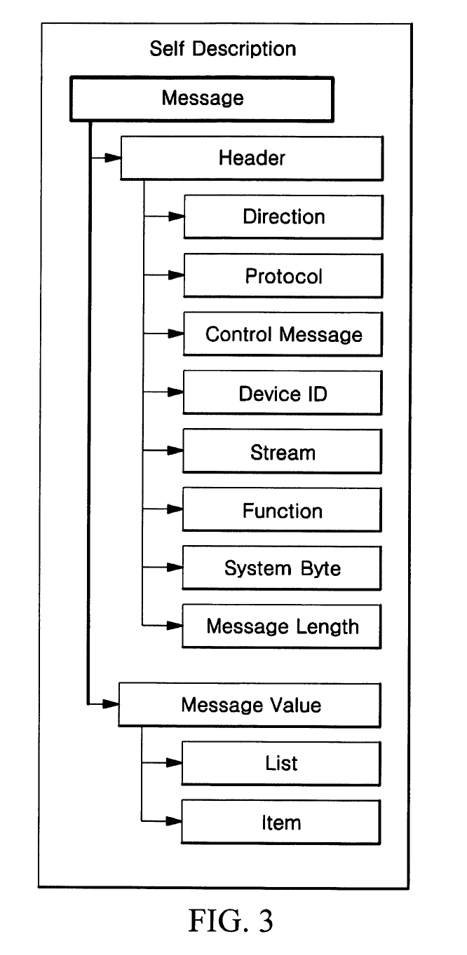

FIG. 3 is a drawing illustrating each element of Self Description 57 which performs mapping in the data processor 55 according to the present invention. Hereinafter, each element of Self Description 57 which maps the data included in the SECS-II message or the OPC message will be described. The elements of Self Description 57 are classified into a Header and a Message Value. The Header Value includes the elements of a Direction, a Protocol, a Control Message, a Device ID, a Stream, a Function, a System Byte, and a Message Length, and the Message Value includes the elements of a List and an Item.

The Direction element is an element indicating a classification code which causes the message to be classified according to a predetermined criterion for each property of the message. The SECS-II message transmitted from the semiconductor equipment 10 or the OPC message transmitted from the PLC equipment 30 is displayed as a combination of names of a Stream and a Function, for example, S5F1, S6F9, S1SF1. Thus, it is possible to classify the SECS-II message in accordance with its property through analyses of the name of the message and the data within the message. Therefore, the data processor 55 discriminates the property of the message via each message data extracted from the SECS analyzer 51 or the OPC converter 53, classifies the message based on the predetermined classification criterion, and inserts the corresponding classification code into the Direction element. Since such Direction element is mainly aimed to enable the distributed monitoring using different server 70 that classifies the message according to the property of the message to monitor the message, a representative example of the classification code which can be inserted into the element Direction may be an identification information indicating the monitoring server 70 designated to monitor the corresponding message according to each classification criterion.

The Protocol element indicates whether the communication protocol receiving the SECS-II or the OPC message is SECS-I, HSMS or OPC.

The Control Message element indicates a control text of the SECS-II message or the OPC message.

The Device ID element indicates an identification symbol ID of the semiconductor equipment 10 or the PLC equipment 30 transmitting the message.

The Stream element indicates information of the SECS-II or the OPC stream.

The Function element indicates information of the SECS-II or the OPC function.

The System Byte element indicates a byte element which is necessary for discriminating the SECS-II or the OPC messages.

The Data Length element indicates a length of each message.

Also, List and Item elements included in the Message Value are elements recording information on a list and an item included in the SECS-II or the OPC message.

Referring back to FIG. 1, the data processor 55 performs the operation of mapping the SECS-II message data extracted from the SECS analyzer 51 and the OPC message generated by the OPC converter 53 to the elements of Self Description to cause additional information to be inserted into the SECS-II message data and the SECS-II message data to be converted into the XML message without a loss.

The XML converter 59 converts the message data mapped to the elements of Self Description into the XML message format and outputs the converted data. XML can declare element, attribute, and entity of the document unlike HTML using only fixed element (Tag. Element) to display the document structurally, as a Markup language designed to transmit the document structured on the internet, and represent the document of various formats using XSL style sheet. There are advantages in that the XML can represent an internet document format as a standardized structure adapted to be applied to a field of the semiconductor equipment 10 needed to unify the message format and the information displayed in XML format makes it easy to build a web-based or computer monitoring system.

Therefore, the SECS analyzer 51 can discriminate the ID of the equipment transmitting the message, the Stream and the Function of the message, and the message length by analyzing the Header included in the message. Further, the List and the Item can be classified and transferred by analyzing the SECS-II message transmitted by the communication protocol.

Furthermore, the OPC converter 53 records a Header data such as a Direction for distribution monitoring, a Control Message for writing ENG, ACK, NAK, a Stream for storing an address of PLC, a Function for recording the data format. The number of the messages is recorded in the List part and the data text is stored in the Item part to complete the XML document similarly to the SECS, considering that the data from actual PLC equipment 30 is generated up to 4.

The message finished by the XML converter 59 is transmitted to the integrated server 70 through SOAP so that it can be monitored using a device such as a computer or PDA.

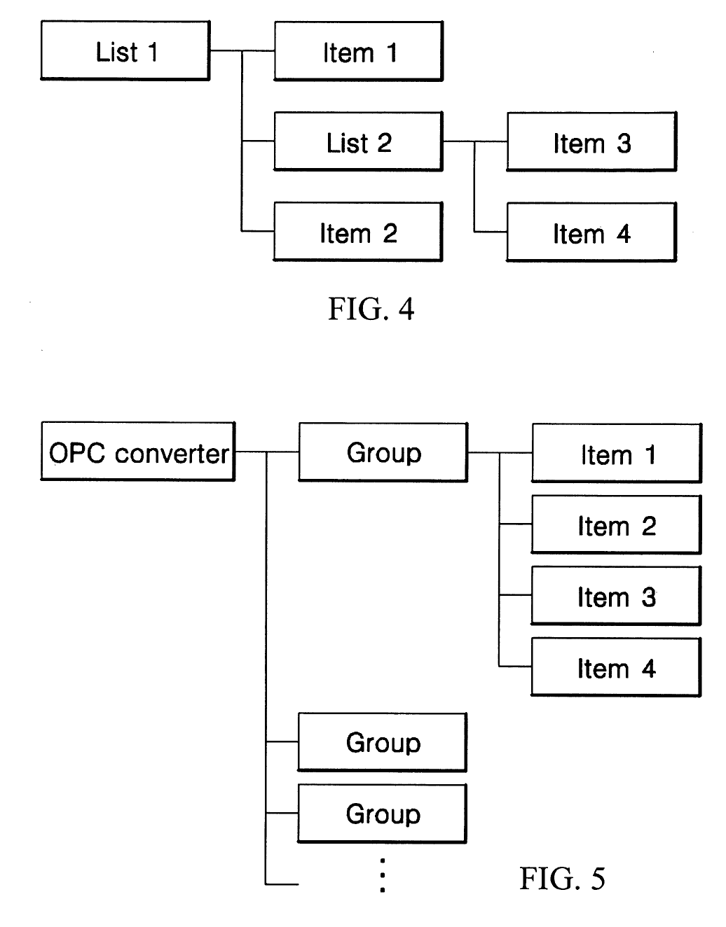

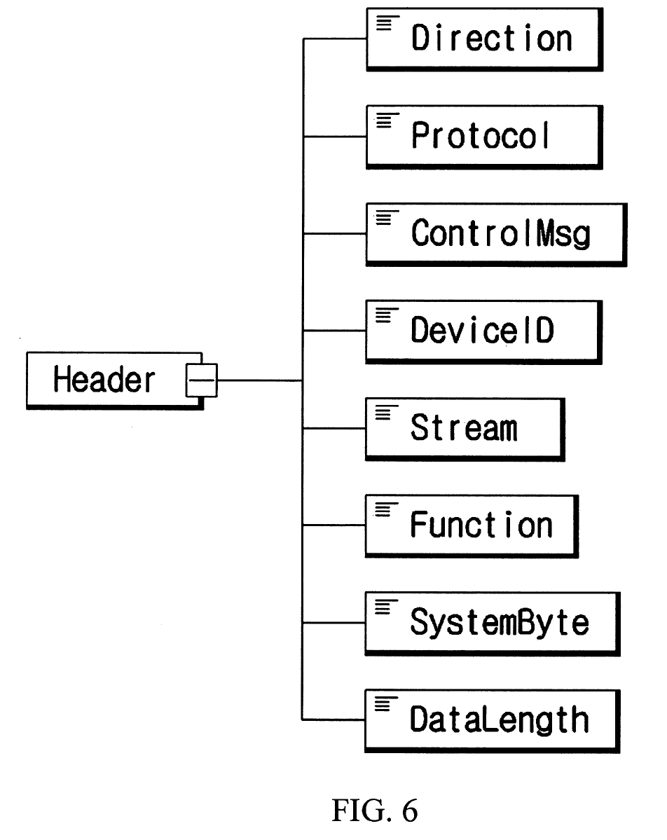

FIG. 4 and FIG. 5 are drawings illustrating respective structures of the SECS-II and the OPC message. As shown, both the SECS-II message and the OPC message are very similar to each other as a tree type, except that the SECS-II has the Item attached to the List without groups unlike the OPC. An XML schema was prepared according to relations among structures, elements, and attributes which are defined to integrate the messages, using XML which represents the internet document format as a standardized structure. The XML Schema includes a Header and a Data (Message Value). FIG. 6 represents a structure of the Header of the XML message converted according to the present invention, in which the Header has elements such as those in Table 1 below.

TABLE 1

| Element | Meaning |
|---|---|
| Direction | Recording destination server specialized for each role in |
| | comparison with distributed monitoring which reduces load |
| | of server |
| Protocol | Recording a kind of Protocol which is used by equipment |
| | transmitting message (SECS-I, HSMS, PLC) |
| ControlMsg | HSMS: recording message text in a case of control message |
| DeviceID | ID of equipment transmitting the message |
| Stream | stream of the message, PLC-address |
| Function | function of the message, PLC-Data type |
| SystemByte | byte necessary to discriminate the messages |
| DataLength | length of the message |

The Data (Message Value) part, except the Header part in the message, is substantially a part in which the data transmitted from the semiconductor equipment 10 and the PLC equipment 30 is stored. As mentioned above, the SECS-II message has a complex structure in which the Item or the List exists. For designation, the list stores the number of child elements.

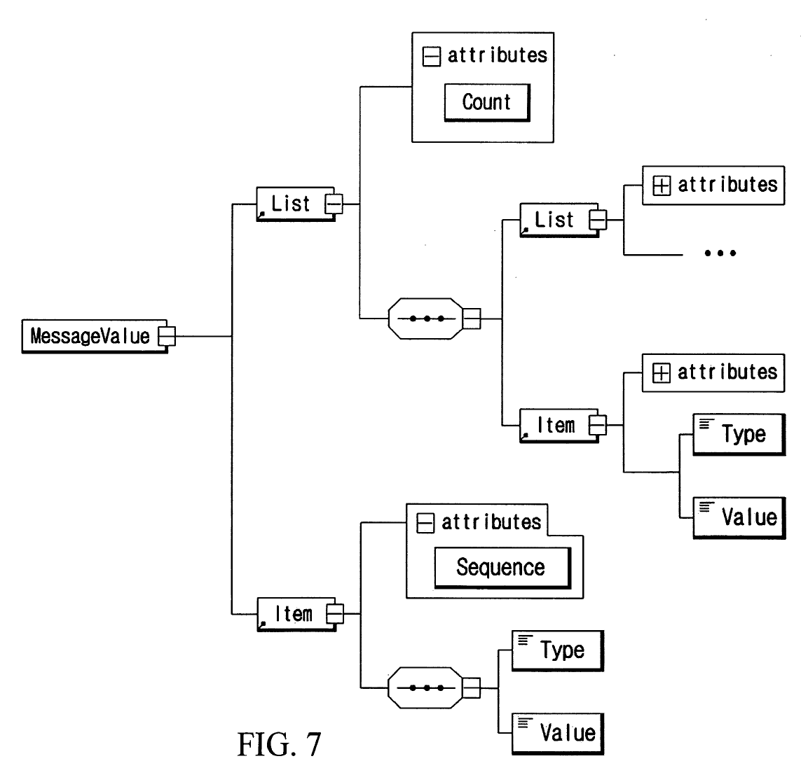

An attribute ‘Count’ is available in the List element of the XML document converted by the XML converter 59, as shown in the data structure of FIG. 7. The Item element includes an attribute ‘Sequence’ in order to check the number of Items designated in the List element in a parsing process. Further, the element Message Value may include the element List and the element Item in large numbers.

Regarding the SECS-II and OPC messages according to the present invention, the SECS-II regulates a structure and a function of the message used between the equipment and the integrated server 70 in the semiconductor manufacturing process. In the SECS-II, a name of the message, which receives and transmits between the equipment and the integrated server 70, is displayed in a combination of the Stream and the Function. The Stream is a classification for the message, and the Function is a message indicating a certain action in the Stream. All Functions used in the SECS-II conform to sequential regulation of a pair of main message and sub message. Table 2 below summarizes a meaning of the message according to each Stream value of the SECS-II message.

TABLE 2

| Stream value | Meaning of message |
|---|---|
| Stream 1 | Equipment Status |
| Stream 2 | Equipment Control and Diagnostics |
| Stream 3 | Material Status |
| Stream 4 | Material Control |
| Stream 5 | Exception Reporting (Exception Alarms) |
| Stream 6 | Data Collection |
| Stream 7 | Process Program Management |
| Stream 8 | Control Program Transfer |
| Stream 9 | System Errors |
| Stream 10 | Terminal Service |
| Stream 11 | Host Files Services (deleted in 1989) |
| Stream 12 | Wafer Mapping |
| Stream 13 | Unformatted Data Set Transfers |

Though the SECS-II regulation is a standard regulation of a Semiconductor Equipment and Materials International (SEMI), it allows the user to define a new message conforming to a characteristic of each equipment. At this time such a user definition message becomes an obstacle factor in understanding the meaning of the SECS-II message consistently.

Further, the PLC is used in the industrial fields to operate and control equipment, and is configured to be resistant to temperature, humidity, or electrical noise and convenient to be handled so that it can stand the poor environment. The PLC is configured with a central processing unit, input/output unit for signal connection with an external machine, and a power supply unit for supplying power to each unit based on a microprocessor and a memory, although specifically not shown. Further, it is configured with a loader program for programming in a memory within the PLC and a peripheral device such as Human Machine Interface (HMI) for controlling the PLC. The PLC programming device is connected to the controller only when inputting or monitoring the program.

Recently, automated equipment interface within the country is mostly configured on a legacy interface such as RS-232C and RS-422/485C. Further, though an environment such as Fieldbus is built for the purpose of centralized information, the control environment still has a limitation. Recently, though an environment construction using the TCP/IP is positively being introduced, it cannot be easily performed due to problems of replacement and compliance with the legacy system.

An international standard OPC regulation is established for automated equipment, and many researches related thereto are being proceeded in order to address such problems and promote new technology developments.

The OPC regulation provides the OPC converter 53 and a client to separate a service provider from a user. The OPC converter 53 is not initially provided by the automated equipment manufacturer but by the application developer, while a module providing a function of the OPC converter 53 currently tends to be mounted on equipment itself by the equipment manufacturer. The OPC client is mostly provided by HMI equipment manufacturer.

Table 3 below shows a conversion example of successive read commands for word unit of 2 blocks in the OPC converter 53.

TABLE 3

| Communication type | Command |
|---|---|
| Legacy communication | OORSBO8%QW0.1.102 |
| OPC communication | Item[1] address: %QW0.1.1 |
| | Item[1] material type: WORD |
| | Item[2] address: %QW0.1.2 |
| | Item[2] material type: WORD |

The legacy interface communication and the OPC-DA communication are designed so that they are all implemented on one HMI operational system to enable communicating by selecting one of two communication methods according to a selection of the operational system. This is to combine advantages of expansivity and direct PLC control only available in the dedicated communication module by adding new OPC client interface while supporting existing legacy communication type. To this end, the OPC conversion module is newly made, and Table 3 shows a conversion example of successive read command for 2 blocks of word unit.

Basically, the message conversion apparatus 50 must be designed to minimize data loss during message conversion procedure, and expression of tree relation between a List and an Item is given a great deal of weight. Therefore, the present invention can provide a technology capable of improving a production efficiency and an operating rate and addressing problems such as failure diagnostics and removal of obstacle factor which can occur in the industry site, by presenting the structure for extracting data from the SECS-II and the OPC message which has a higher usage of various communication protocol of the semiconductor industry equipment, and making the integrated XML message.

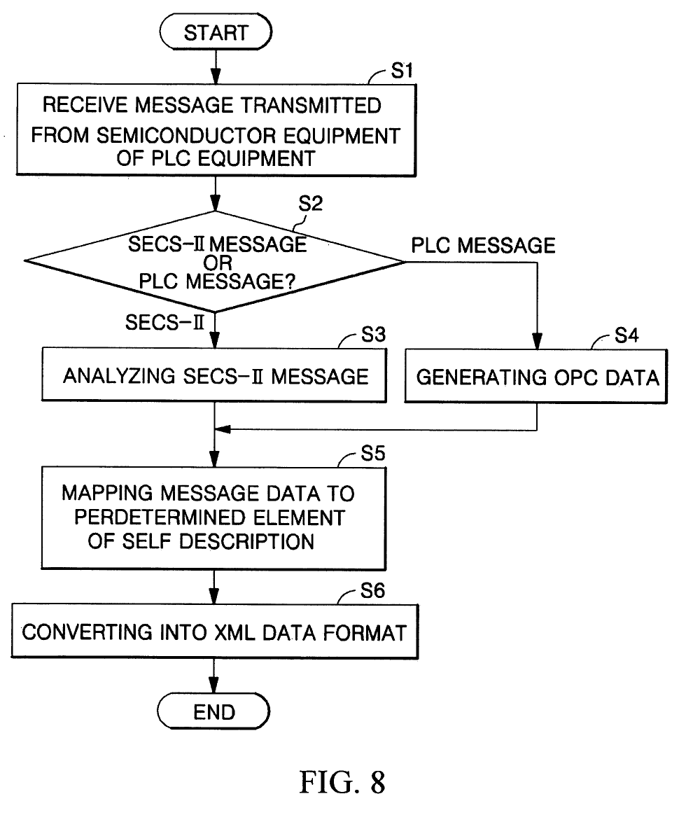

FIG. 8 is a flow chart illustrating a process for converting a message transmitted between the industrial equipment and the server according to the present invention.

According to the present invention, the message conversion apparatus 50 receives a message transmitted from the semiconductor equipment 10 or the PLC equipment 30 (S1). The method of processing the message depends on a kind of message that is received. If the message received is a SECS-II message of SECS-I protocol or HSMS protocol transmitted from the semiconductor equipment 10 (S2), the SECS analyzer 51 analyzes the Header and the Data of the SECS-II message (S3). Meanwhile, if the message received is a PLC message transmitted from the PLC equipment 30 (S2), the OPC converter 53 generates the OPC data using the PLC message (S4).

Successively, the data processor 55 maps the analyzed SECS-II message data or the generated OPC data to each element of Self Description shown in FIG. 3 and outputs the message data mapped to each element of Self Description to the XML converter 59 (S5). The XML converter 59 converts the message data mapped to each element of Self Description to an XML format and transmits it to the integrated server 70 through SOAP (S6).

Herein, the operation of each procedure will not be explained since it is same as that performed by each of the SECS analyzer 51, the OPC converter 53, the data processor 55, and the XML converter 59, each of which is shown as a component of the message conversion apparatus 50 of FIG. 1.

The conversion method of the message transmitted between the semiconductor equipment 10 or the PLC equipment 30 and the integrated server 70 enables the integrated monitoring of various industrial equipment, as well monitoring using the internet or computer networks. Since the Self Description applied to the present invention is so designed to be easily expanded to the data structure considering a separate application, the classes of the Self Description may be modified later if necessary.

While the present novel concept has been described with reference to the particular illustrative implementations, it is not to be restricted by those implementations but only by the appended claims. It is to be appreciated that those skilled in the art can change or modify the implementations without departing from the scope and spirit of the present disclosure.

What is claimed is:

1. A message conversion apparatus for unified monitoring of industrial equipment, comprising:
an SECS analyzer for analyzing a Header and a Data of Semiconductor Equipment Communications Standard-II message transmitted from a semiconductor equipment to extract data included in the message;
an OPC converter for generating data of OLE for Process Control (OPC) protocol by analyzing PLC message transmitted from PLC equipment;
a data processor for extracting and mapping data inputted from the SECS analyzer or the OPC converter to a predetermined element of Self Description; and
an XML converter for converting the message data mapped to the element of Self Description inputted from the data processor to an eXtensible Markup Language (XML) message format.

2. The message conversion apparatus of claim 1, wherein the SECS analyzer receives the SECS-II message from the semiconductor equipment through SECS-I protocol or High-Speed SECS Message Services (HSMS) protocol.

3. The message conversion apparatus of claim 1, wherein the element of Self Description is classified into a Header part and a Message Value part, and wherein the Header part includes an element Protocol indicating a communication protocol through which the message is transmitted, an element Control Message indicating control text of the message, an element Device ID indicating an identification code of the industrial equipment transmitting the message, an element Stream indicating Stream information of the message, an element Function indicating a Function information of the message, and an element Data Length indicating a message length of the message.

4. The message conversion apparatus of claim 2, wherein the element of Self Description is classified into a Header part and a Message Value part, and wherein the Header part includes an element Protocol indicating a communication protocol through which the message is transmitted, an element Control Message indicating control text of the message, an element Device ID indicating an identification code of the industrial equipment transmitting the message, an element Stream indicating Stream information of the message, an element Function indicating a Function information of the message, and an element Data Length indicating a message length of the message.

5. The message conversion apparatus of claim 3, wherein the element Protocol of the Header part is a SECS-I, HSMS, or OPC protocol.

6. The message conversion apparatus of claim 4, wherein the element Protocol of the Header part is a SECS-I, HSMS, or OPC protocol.

7. The message conversion apparatus of claim 3, wherein the Header part further includes an element Direction indicating a classification code which causes each message to be classified in accordance with a predetermined classification criterion for each property of the message, and the corresponding classification code is mapped to the element Direction by analyzing the extracted message data to confirm the property of the message and classifying the message in accordance with the predetermined classification criterion, when mapping the extracted message data to the predetermined element of Self Description.

8. The message conversion apparatus of claim 4, wherein the Header part further includes an element Direction indicating a classification code which causes each message to be classified in accordance with a predetermined classification criterion for each property of the message, and the corresponding classification code is mapped to the element Direction by analyzing the extracted message data to confirm the property of the message and classifying the message in accordance with the predetermined classification criterion, when mapping the extracted message data to the predetermined element of Self Description.

9. The message conversion apparatus of claim 7, wherein the element Direction is an element indicating an identification information of a monitoring integrated server which is pre-assigned to monitor the message in accordance with the property of the message.

10. The message conversion apparatus of claim 8, wherein the element Direction is an element indicating an identification information of a monitoring integrated server which is pre-assigned to monitor the message in accordance with the property of the message.

11. The message conversion apparatus of claim 3, wherein the Message Value part includes an element List indicating a List information of the SECS-II or OPC message and an Item information of the SECS-II or OPC message.

12. The message conversion apparatus of claim 4, wherein the Message Value part includes an element List indicating the list information of the message and Item information of the message.

13. The message conversion apparatus of claim 1, wherein the XML converter transmits the converted XML data to the integrated server through Simple Object Access Protocol (SOAP).

14. The message conversion apparatus of claim 2, wherein the XML converter transmits the converted XML data to the integrated server through Simple Object Access Protocol (SOAP).

15. A method providing integrated monitoring of industrial equipment, comprising the steps of:
receiving an SECS-II or PLC message from industrial equipment;
determining a message format of said message;
transmitting said message to a corresponding format converting or analyzer;
transmitting said message to a data processor to extract and map data to a predetermined element of Self Description;
converting mapped data of Self Description into XML data format; and
transmitting XML data to a monitoring system.
